(19) United States
(12) Patent Application Publication
(10) Pub. No.: US 2008/0122806 A1
(43) Pub. Date: May 29, 2008

(54) Method and Apparatus for Inputting Character Through Pointing Device

(76) Inventor: Jaewoo Ahn, Gyeonggi-Do (KR)

Correspondence Address: IPLA P.A., 3580 WILSHIRE BLVD., 17TH FLOOR, LOS ANGELES, CA, 90010, US

(21) Appl. No.: 11/813,396

(22) PCT Filed: Jan. 5, 2006
(86) PCT No.: PCT/KR06/00046

§ 371 Date: Jul. 5, 2007

(30) Foreign Application Priority Data
Jan. 5, 2005 (KR) 10-2005-0000712
Dec. 27, 2005 (KR) 10-2005-0130184
Jan. 5, 2006 (KR) 10-2006-0001272

(51) Int. Cl. G06F 3/033

(52) U.S. Cl. 345/179

(57) ABSTRACT

Disclosed is a method and apparatus for inputting characters through a pointing device such as a stylus or a mouse. The method includes: (a) dividing an input area of the pointing device into a plurality of input sub-areas and assigning a plurality of characters constituting a character set of a current character mode to each of the input sub-areas; (b) inputting an input pattern through the pointing device in a selected one of the input sub-areas; and (c) selectively outputting one of the characters assigned to the selected input sub-area according to whether the input pattern of the pointing device is a point, a line having more than a predetermined length, a line bent a predetermined number of times with more than a predetermined angle and having more than a predetermined length, or a round shape.

### TECHNICAL FIELD

The present invention relates to a method and apparatus for inputting characters through a pointing device such as a stylus or a mouse.

### BACKGROUND ART

Conventionally, a user can input a character by pressing a key of a virtual keyboard displayed on a touch screen of a personal digital assistant (PDA) by means of a stylus, or by directly writing a character on an input unit of a display unit by means of the stylus.

However, when the virtual keyboard is used, it is very difficult for a user to input a character rapidly and accurately since there are a large number of keys in the virtual keyboard and each of the keys is small in size. On the other hand, when the user directly writes a character on the input unit of the display unit, it is difficult for the user to rapidly input the character. Further, it may be difficult to identify the character inputted by the user.

### DISCLOSURE OF INVENTION

### Technical Solution

The present invention provides a method and apparatus for inputting characters through a pointing device, which allows a user to select input areas of the characters rapidly and accurately by reducing the number of input areas and to output the characters assigned to each of the input areas selectively and conveniently.

### ADVANTAGEOUS EFFECTS

According to the present invention, it is possible to easily and rapidly input characters on an apparatus such as a personal digital assistant equipped with a pointing device.

### BRIEF DESCRIPTION OF THE DRAWINGS

The above and other features and advantages of the present invention will become more apparent by describing in detail exemplary embodiments thereof with reference to the attached drawings in which:

FIG. 1 is a personal digital assistant (PDA) using a stylus as a pointing device;

FIGS. 2 to 5 are keypads each having 4-by-3 keypad area on which numerals, English alphabets, symbols, or Korean alphabets are arranged according to an embodiment of the present invention;

FIG. 6 is a method of selectively inputting a plurality of characters assigned to an input area through a pointing device according to an embodiment of the present invention;

FIG. 7 is another embodiment of a third input pattern shown in FIG. 6;

FIG. 8 is a method of selectively inputting a plurality of characters assigned to an input area through a pointing device according to another embodiment of the present invention;

FIG. 9 is a method of inputting a character in an extended input area;

FIGS. 10 to 13 are methods of inputting characters according to the methods of FIGS. 8 and 9;

FIG. 14 is a flow chart of a method of inputting a character according to an embodiment of the present invention; and

FIG. 15 is a block diagram of an apparatus for inputting a character according to an embodiment of the present invention.

### BEST MODE FOR CARRYING OUT THE INVENTION

According to an aspect of the present invention, there is provided a method of inputting a character through a pointing device, the method including: (a) dividing an input area of the pointing device into a plurality of input sub-areas and assigning a plurality of characters constituting a character set of a current character mode to each of the input sub-areas; (b) inputting an input pattern through the pointing device in a selected one of the input sub-areas; and (c) selectively outputting one of the characters assigned to the selected input sub-area according to whether the input pattern of the pointing device is a point, a line having more than a predetermined length, a line bent a predetermined number of times with more than a predetermined angle and having more than a predetermined length, or a round shape.

Preferably, in the step (c), a first character is selected among the characters assigned to the selected input sub-area when a point is input through the pointing device, a second character is selected when a line having more than a predetermined length is input, a third character is selected when a line bent a predetermined number of times with more than a predetermined angle and having more than a predetermined length is input, or a predetermined character or command is selected when a round shape is input.

Preferably, in the step (c), when it is determined whether the input pattern is a point, a line having more than a predetermined length, a line bent a predetermined number of times with more than a predetermined angle and having more than a predetermined length, or a round shape, a line proceeding from the outside to the inside of an input area and a line proceeding from the inside to the outside of the input area are not considered as part of the input pattern.

Preferably, in the step (b), when the input pattern is input through the pointing device in an extended input sub-area that is extended by a predetermined size from each of the input sub-areas, the input pattern is considered to be input in the selected input sub-area.

According to another aspect of the present invention, there is provided an apparatus for inputting a character through a pointing device, including: an input unit allowing a user to input an input pattern through the pointing device in an input area of the pointing device, the input area being divided into a plurality of input sub-areas each being assigned a plurality of characters constituting a character set of a current character mode; and a processing unit selectively outputting one of characters assigned to the selected input sub-area according to whether the input pattern of the pointing device is a point, a line having more than a predetermined length, a line bent a pre-determined number of times with more than a predetermined angle and having more than a predetermined length, or a round shape.

### MODE FOR THE INVENTION

Exemplary embodiments in accordance with the present invention will now be described in detail with reference to the accompanying drawings.

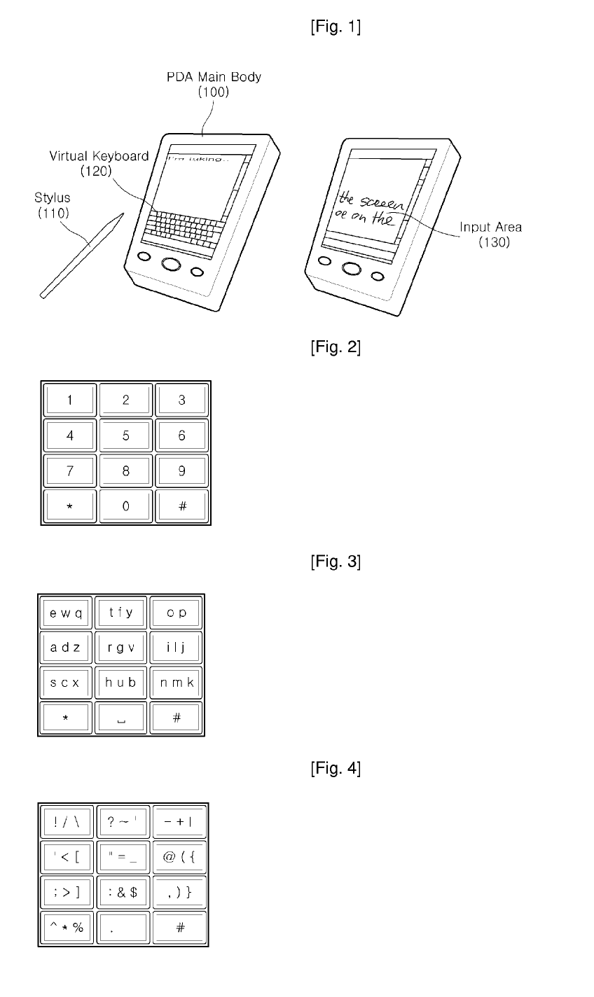

FIG. 1 is a personal digital assistant (PDA) using a stylus as a pointing device.

A PDA includes a main body 100 and a stylus 110. The main body 100 includes a display unit serving as a touch screen and displaying data. A user inputs a command by selecting an icon or a menu displayed on the display unit by means of the stylus 110, or inputs a text by pressing keys on a virtual keyboard 120 displayed on the display unit or by directly writing characters on an input area 130.

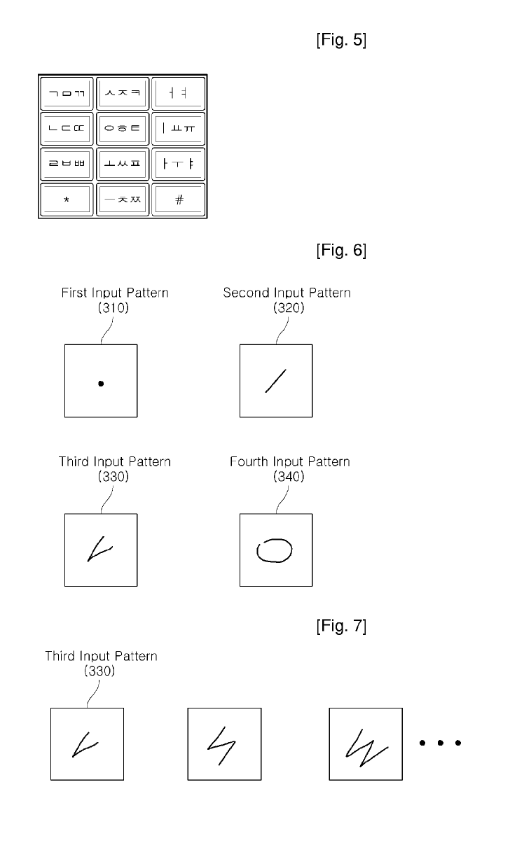

FIGS. 2 to 5 are keypads each having 4-by-3 keypad area on which numerals, English alphabets, symbols, or Korean alphabets are arranged according to an embodiment of the present invention.

A character set consisting of numerals, English alphabets, symbols, or Korean alphabets is provided on a keypad having 4-by-3 keypad area and is input by means of a pointing device. In FIG. 2, numerals are arranged in the same manner as those of a telephone having a typical 4-by-3 keypad. In FIGS. 3 to 5, English alphabets, symbols, and Korean alphabets are arranged in consideration of usage frequency or operation efficiency.

In the 4-by-3 keypad arranged in this manner, a character is input by selecting a key on the 4-by-3 keypad through the pointing device shown in FIG. 1. The character set of numerals, English alphabets, symbols, or Korean alphabets, or other character set corresponds to the 4-by-3 keypad according to a selected character mode.

In addition to the 4-by-3 keypad area provided for inputting characters, an additional area for inputting a command, such as mode-changing, deleting, or spacing, may be provided. Further, the remaining input area other than the 4-by-3 keypad area and the above-mentioned additional area may be set as a single input area for convenience of use. For example, the remaining input area other than the 4-by-3 keypad area may be set as a single input area and be assigned a spacing command. When the spacing command needs to be input during inputting characters, the pointing device has only to be moved out of the 4-by-3 keypad area without the need to press a key (e.g., a button ‘0’ or ‘#’) that corresponds to the spacing command.

FIG. 6 is a method of selectively inputting a plurality of characters assigned to an input area through a pointing device according to an embodiment of the present invention.

For example, when one of the character sets shown in FIGS. 2 to 5 is displayed on the display unit according to a current character mode, a user selects one of keys constituting the displayed character set and inputs a desired character through the method shown in FIG. 6.

A first input pattern 310 is to touch a key like marking the key with a dot. A second input pattern 320 is to draw a line having more than a predetermined length. A third input pattern 330 is to draw a line bent with more than a predetermined angle and having more than a predetermined length. A fourth input pattern 340 is to draw a round shape. When the first input pattern 310 is input, a first character is input among a plurality of characters assigned to a corresponding key. When the second input pattern 320 is input, a second character is input. When the third input pattern 330 is input, a third character is input. When the fourth input pattern 340 is input, a predetermined character is output or a predetermined command is performed in a selected area.

A position of a dot or a position and direction of a line does not matter in a selected input area. A length of the line does not matter if only the line has more than a pre-determined length. For example, in case of a pixel unit, a line having more than five pixels may be considered to be a line having a predetermined length. When a stylus is off from the input area, a current input operation is considered to be completed. On the other hand, the stylus needs not to be off from the input area when the current input operation can be clearly distinguished from the next input operation. When the stylus is temporarily deviated from a selected input area within a predetermined range during the input operation, the input operation may be considered to be performed in the selected input area.

That is, for example, when a selected input area in a display unit is small in size, it is difficult for a user to input the above-mentioned input patterns in the selected input area. Thus, an area falling within a predetermined range from the input area is preferably defined as an extended input area so that an input operation in the extended input area can be considered to be an input operation in the selected input area. The input operation in the extended input area will be described with reference to FIGS. 9 to 13.

For example, in an English alphabet mode having the character set arranged as shown in FIG. 3, when a dot is marked by the use of the first input pattern 310, an alphabet ‘e’ is input in a key input area in which characters ‘ewq’ are assigned. When a line is drawn by the use of the second input pattern 320, an alphabet ‘w’ is input. When a bent line is drawn by the use of the third input pattern 330, an alphabet ‘q’ is input. When a round shape is drawn by the use of the fourth input pattern 340, a numeral ‘1’ is input. The numeral ‘1’ is previously set in the key input area.

In an area provided for changing a character mode, the character mode may be changed according to the input pattern. In a delete area, a user can delete character by character, word by word, sentence by sentence, or all characters according to the input pattern. For example, the character mode is changed to a lowercase mode when the first input pattern 310 is input in the area for changing the character mode, the character mode is changed to a mode in which a first character is an uppercase letter and the remaining characters are lowercase letters when the second input pattern 320 is input, the character mode is changed to an uppercase mode when the third input pattern 330 is input, and the character mode is changed to a numeral mode when the fourth input pattern 340 is input. Further, for example, a single character is deleted when the first input pattern 310 is input in the delete area, a single word is deleted when the second input pattern 320 is input, a single sentence is deleted when the third input pattern 330 is input, and all characters are deleted when the fourth input pattern 340 is input. In addition, for example, when the first input pattern 310 is input in an area corresponding to a key ‘*’ in a current character mode, a symbol is input and a character mode is returned from the current character mode to an original character mode.

In addition, a current input operation may be distinguished from the next input operation when the current input operation is not performed during a predetermined time interval with a stylus contacting an input area.

FIG. 7 is another embodiment of the third input pattern shown in FIG. 6.

A line is bent one time in the third input pattern 330 shown in FIG. 6, while a line bent two or more times as shown in FIG. 7 is considered to be a line inputted in the third input pattern 330.

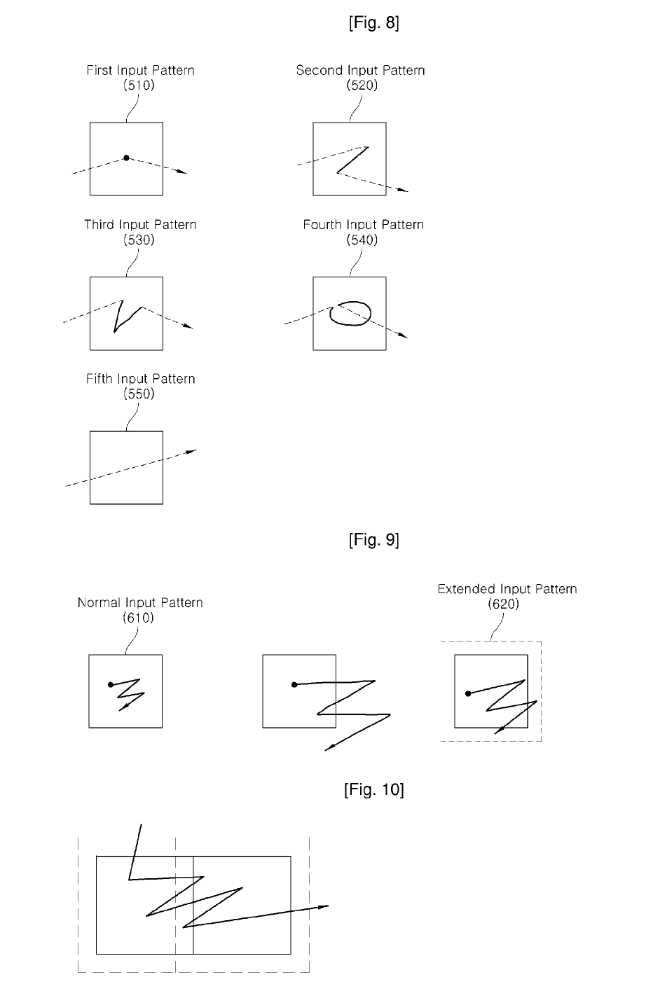

FIG. 8 is a method of selectively inputting a plurality of characters assigned to an input area through a pointing device according to another embodiment of the present invention.

Referring to FIG. 8, a pointing device may be moved from the outside to the inside of an input area or from the inside to the outside of the input area to input characters continuously and rapidly. In FIG. 8, a dotted line indicates a line drawn by the pointing device moving from the outside to the inside of an input area or from the inside to the outside of the input area. The dotted line is not considered as part of the input pattern. Thus, first to fourth input patterns 510 to 540 shown in FIG. 8 are the same as the first to fourth input pattern 310 to 340 shown in FIG. 6, respectively.

A fifth input pattern 550 shown in FIG. 8 indicates that a line passes through an input area without selecting a character in the input area. That is, in order to determine the input pattern an input starting point, an input ending point, and a line bent with more than a predetermined angle are considered. Preferably, even though an input pattern is temporarily departed from a selected input area within a predetermined range, the input pattern is considered to be input in the selected input area.

FIG. 9 is a method of inputting a character in an extended input area.

In a conventional input method, an input pattern is required to be inputted in a normal input area 610 or an input starting point of the input pattern is required to be located in the normal input area 610. However, in the present invention, an input area consists of the normal input area 610 and the extended input area 620. The size of extended input area 620 may depend on the size of display unit or the size of input area. For example, the extended input area needs to be large in a small display unit since a stylus is apt to be deviated from the normal input area 610. On the other hand, the extended input area needs to be small in a large display unit since the stylus is not apt to be deviated from the normal input area 610.

FIGS. 10 to 13 are methods of inputting characters according to the methods of FIGS. 8 and 9.

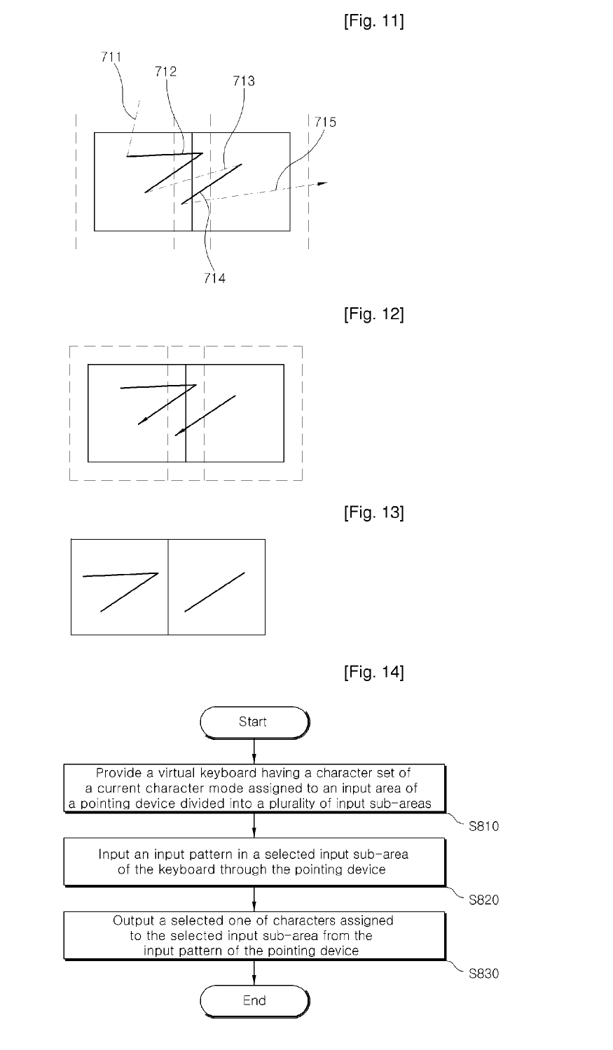

For example, when an input line is drawn as shown in FIG. 10, a dotted line 711 is not considered to be part of an input pattern and a line 712 is considered to be part of an input pattern. The line 711 is considered to be entered to an input area shown in FIG. 11 when the line 711 is departed from an extended input area of the previous input area. A dotted line 713 proceeding to the outside of the extended input area is not considered to be part of an input pattern and a line 714 is considered to be part of an input pattern. A dotted line 715 drawn toward the outside of the extended input area is not considered to be part of an input pattern.

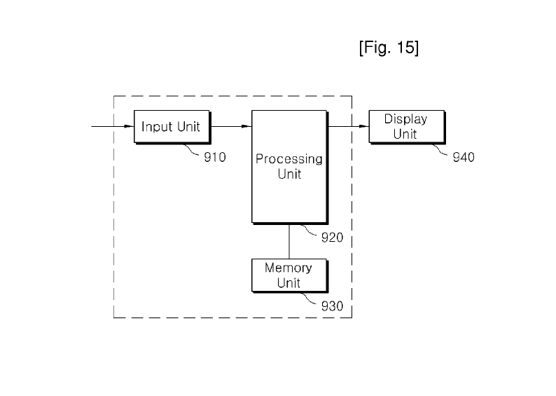

As a result, as shown in FIG. 12, the third input pattern and second input pattern are considered to be input in the extended input area. Accordingly, the input patterns are considered to be input in the normal input area as shown in FIG. 13.

On the other hand, it is very difficult to draw a line or round shape in a very small input area. In this case, when an input starting point is located in the input area, the line or round shape may be considered to be part of an input pattern in the input area even though the line or round shape is temporarily deviated from the input area during an input operation. This is similar to the above-mentioned input method in an input area including normal and extended input areas. However, in this input method, when an input operation is continuously performed, the input operation is considered to be performed in the input area even though a stylus is considerably deviated from the input area.

FIG. 14 is a flow chart of a method of inputting characters according to an embodiment of the present invention.

An input area of a pointing device is divided into a plurality of input sub-areas, and a plurality of characters constituting a character set of a current character mode is assigned to each of the input sub-areas (S810). For example, an input area is divided into a plurality of input sub-areas arranged in 4-by-3 form, and one of the character sets shown in FIGS. 2 to 5 is assigned to the sub-areas according to a current character mode.

One of the input sub-areas is selected and an input pattern is input in the selected input sub-area by means of the pointing device (S820). For example, when a virtual keyboard having character sets shown in FIGS. 2 to 5 is provided on a display unit, a key is selected and one of the input patterns shown in FIGS. 6 to 8 is input to select one of characters assigned to the key.

The selected character is output according to whether the input pattern is a point, a line having more than a predetermined length, a line bent a predetermined number of times with more than a predetermined angle and having more than a predetermined length, or a round shape (S830). For example, a first character is selected when a point is input through a pointing device, a second character is selected when a line having more than a predetermined length is input, a third character is selected when a line bent a predetermined number of times with more than a predetermined angle is input, or a predetermined character or command is selected when a round shape is input.

FIG. 15 is a block diagram of an apparatus for inputting characters according to an embodiment of the present invention.

The apparatus includes an input unit 910, a processing unit 920, and a memory unit 930. The input unit 910 includes, for example, a touch screen allowing a user to input characters through a pointing device. For example, an input area is divided into a plurality of input sub-areas arranged in 4-by-3 form, and each of the character sets shown in FIGS. 2 to 5 is assigned to the sub-areas according to a current character mode.

The processing unit 920 selectively outputs a plurality of characters assigned to the selected area according to whether an input pattern is a point, a line having more than a predetermined length, a line bent with more than a predetermined angle a pre-determined times, or a round shape. For example, a first character is selected among a plurality of characters assigned to a selected area when a dot is input through the pointing device, a second character is selected when a line having more than a pre-determined length is input, a third character is selected when a line bent a pre-determined number of times with more than a predetermined angle is input, or a pre-determined character or command is selected when a round shape is input.

The memory unit 930 may store a mapping relation between a character set arranged in an input area and an input pattern of a pointing device, or a current character mode.

On the other hand, the above-mentioned method of inputting a character can be written with a computer program. Codes and code segments constituting the program can be easily induced by computer programmers in the art. The program is stored in computer readable recording media and is read and executed by a computer to implement the above-mentioned method. Examples of the computer readable media include magnetic recording media, optical recording media, and carrier wave media.

As apparent from the above description, the present invention can be applied to a method and apparatus for inputting characters through a pointing device such as a stylus or a mouse.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention can be efficiently applied to a field related to a method and apparatus for inputting characters through a pointing device such as a stylus or a mouse.

1. A method of inputting a character through a pointing device, the method comprising:
(a) dividing an input area of the pointing device into a plurality of input sub-areas and assigning a plurality of characters constituting a character set of a current character mode to each of the input sub-areas;
(b) inputting an input pattern through the pointing device in a selected one of the input sub-areas: and
(c) selectively outputting one of the characters assigned to the selected input sub-area according to whether the input pattern of the pointing device is a point, a line having more than a predetermined length, a line bent a predetermined number of times with more than a predetermined angle and having more than a predetermined length, or a round shape.

2. The method of claim 1, wherein, in the step (a), the input area of the pointing device is divided into a plurality of input sub-areas arranged in 4-by-3 form and a plurality of characters constituting a character set of a current character mode is assigned to each of the input sub-areas.

3. The method of claim 1, wherein, in the step (c), a first character is selected among the characters assigned to the selected input sub-area when a point is input through the pointing device, a second character is selected when a line having more than a predetermined length is input, a third character is selected when a line bent a predetermined number of times with more than a predetermined angle and having more than a predetermined length is input, or a predetermined character or command is selected when a round shape is input.

4. The method of claim 1, wherein, in the step (c), when it is determined whether the input pattern is a point, a line having more than a predetermined length, a line bent a predetermined number of times with more than a predetermined angle and having more than a predetermined length, or a round shape, a line proceeding from the outside to the inside of an input area and a line proceeding from the inside to the outside of the input area are not considered as part of the input pattern.

5. The method of claim 1, wherein, in the step (b), when the input pattern is input through the pointing device in an extended input sub-area that is extended by a predetermined size from each of the input sub-areas, the input pattern is considered to be input in the selected input sub-area.

6. The method of claim 1, wherein, in the step (b), when a starting point of the input pattern of the pointing device is located in the selected input sub-area and the input pattern is continuously input, the input pattern is considered to be input in the input sub-area even though the input pattern is temporarily deviated from the input sub-area, and, when the starting point of the input pattern is located in the selected input sub-area and the input pattern is not continuously input, an input operation performed in the input sub-area is completed.

7. An apparatus for inputting a character through a pointing device, comprising:
an input unit allowing a user to input an input pattern through the pointing device in an input area of the pointing device, the input area being divided into a plurality of input sub-areas each being assigned a plurality of characters constituting a character set of a current character mode; and
a processing unit selectively outputting one of characters assigned to the selected input sub-area according to whether the input pattern of the pointing device is a point, a line having more than a predetermined length, a line bent a predetermined number of times with more than a predetermined angle and having more than a predetermined length, or a round shape.

8. The apparatus of claim 7, wherein the input unit allows a user to input an input pattern through the pointing device in an input area of the pointing device, the input area being divided into a plurality of input sub-areas arranged in 4-by-3 form each being assigned a plurality of characters constituting a character set of a current character mode.

9. The apparatus of claim 7, wherein the processing unit is configured such that a first character is selected among the plurality of characters assigned to the selected input sub-area when the input pattern of the pointing device is a point, a second character is selected when the input pattern is a line having more than a predetermined length, a third character is selected when the input pattern is a line bent a predetermined number of times with more than a predetermined angle and having more than a predetermined length, or a predetermined character or command is selected when the input pattern is a round shape.

10. The apparatus of claim 7, wherein, when it is determined by the processing unit whether the input pattern is a point, a line having more than a predetermined length, a line bent a predetermined number of times with more than a predetermined angle and having more than a predetermined length, or a round shape, a line proceeding from the outside to the inside of an input area and a line proceeding from the inside to the outside of the input area are not considered as part of the input pattern.

11. The apparatus of claim 7, wherein, when the input pattern is input to the input unit through the pointing device in an extended input sub-area that is extended by a predetermined size from each of the input sub-areas, the input pattern is considered to be input in the selected input sub-area.

12. The apparatus of claim 7, wherein, when a starting point of the input pattern of the pointing device is located in the selected input sub-area and the input pattern is continuously input to the input unit, the input pattern is considered to be input in the input sub-area even though the input pattern is temporarily deviated from the input sub-area, and, when the starting point of the input pattern is located in the selected input sub-area and the input pattern is not continuously input, an input operation performed in the input sub-area is completed.

13. A computer readable recording medium storing a program for executing in a computer the method of claim 1.
